(19) United States
(12) Patent Application Publication
(10) Pub. No.: US 2025/0167883 A1
(43) Pub. Date: May 22, 2025

(54) FIBER OPTIC CABLE TESTING TOOL

(71) Applicant: INTERNATIONAL BUSINESS MACHINES CORPORATION, ARMONK, NY (US)

(72) Inventors: Faezeh Gholami, Ridgewood, NJ (US); Rafaela Frota, Poughkeepsie, NY (US); John S. Werner, Fishkill, NY (US); Andrew C. M. Hicks, Highland, NY (US)

(21) Appl. No.: 18/514,222

(22) Filed: Nov. 20, 2023

(51) Int. Cl. H04B 10/07; H04B 10/25; H04L 41/14

(52) U.S. Cl. CPC H04B 10/07; H04B 10/25; H04L 41/145

(57) ABSTRACT

A method of testing fiber optic communication lanes includes sending a plurality of test parameters by a first end unit of a testing tool to a second end unit of the testing tool through at least one communication lane of a plurality of communication lanes that extend from a first cable endpoint to a second cable endpoint through at least one fiber optic cable. The first cable endpoint is connected to the first end unit and the second cable endpoint is connected to the second end unit, and the plurality of test parameters comprises wavelengths of a plurality of test signals. The method further includes sending the plurality of test signals by the first end unit to the second end unit through the plurality of communication lanes, and receiving test results through the at least one communication lane of the plurality of communication lanes.

### BACKGROUND

The present disclosure relates to communication systems, and more specifically, to testing tools for fiber optic communication lanes.

Data centers can include a large amount of fiber cables that are being routed between components. Data centers can include routes between multiple systems and patch panels, and data centers can also employ multiple different fiber cable polarities. Despite meticulous planning, sometimes an incorrect cable is used during a new installation or upgrade. This can lead to incorrect data or a lack of data through one or more communication lanes.

### SUMMARY

According to one embodiment of the present disclosure, a method of testing fiber optic communication lanes includes sending a first plurality of test parameters by a first end unit of a testing tool to a second end unit of the testing tool through at least one communication lane of a plurality of communication lanes that extend from a first cable endpoint to a second cable endpoint through at least a first fiber optic cable. The first cable endpoint is connected to the first end unit and the second cable endpoint is connected to the second end unit, and the first plurality of test parameters comprises a plurality of wavelengths of a first plurality of test signals. The method further includes sending the first plurality of test signals by the first end unit to the second end unit through the plurality of communication lanes, and receiving test results by the first end unit from the second end unit through the at least one communication lane of the plurality of communication lanes.

According to one embodiment of the present disclosure, a fiber optic communication lanes testing system includes a first end unit configured to connect to a first cable endpoint of a first fiber optic cable and configured to send metadata communication about a test and to send optical test signals through at least some of the communication lanes in the first fiber optic cable, a second end unit configured to connect to a second cable endpoint that is communicatively connected to the first cable endpoint and configured to receive the metadata communication about the test and the optical test signals from at least some of the communication lanes in the first fiber optic cable, and a path database communicatively connected to at least one of the first end unit and the second end unit, the path database comprising data representing intended communication lanes through a data center to connect a first server to a second server, wherein the intended communication lanes extend through at least the first fiber optic cable.

According to one embodiment of the present disclosure, a method of testing fiber optic communication lanes includes receiving test parameters from a first end unit of a testing tool by a second end unit of the testing tool through at least one of a plurality of communication lanes that extend from a first cable endpoint to a second cable endpoint through at least a first fiber optic cable, wherein the first cable endpoint is connected to the first end unit and the second cable endpoint is connected to the second end unit, and the test parameters comprise an order of the test signals. The method further includes receiving the test signals from the first end unit by the second end unit through the plurality of communication lanes, and analyzing the test signals based on the test parameters to determine if the first fiber optic cable has a correct polarity to connect each of the plurality of communication lanes as intended in a data center.

### BRIEF DESCRIPTION OF THE DRAWINGS

FIG. 1 is a schematic view of a data center, in accordance with an embodiment of the present disclosure.

FIG. 2 is a schematic view of communication lanes of the data center, in accordance with an embodiment of the present disclosure.

FIG. 3 is a schematic view of a testing tool connected to the communication lanes, in accordance with an embodiment of the present disclosure.

FIG. 4 is a flowchart of a method of using the testing tool, in accordance with an embodiment of the present disclosure.

FIG. 5 is a flowchart of a method of operating the testing tool, in accordance with an embodiment of the present disclosure.

FIG. 6 is a flowchart of an alternative method of operating the testing tool, in accordance with an embodiment of the present disclosure.

FIG. 7 is a schematic view of the testing tool connected to erroneously connected communication lanes, in accordance with an embodiment of the present disclosure.

FIG. 8 is a flowchart of a method of analyzing test results, in accordance with an embodiment of the present disclosure.

### DETAILED DESCRIPTION

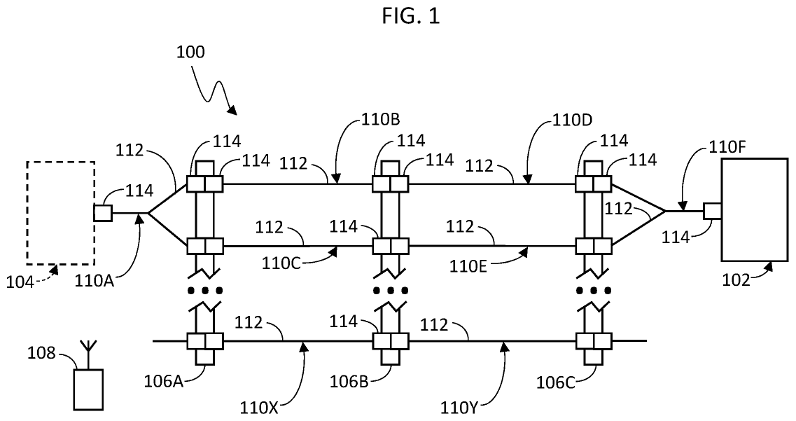

FIG. 1 is a schematic view of data center 100. In the illustrated embodiment, data center 100 includes existing server 102 and new server 104 (collectively “servers 102/104”), patch panels 106A-106C (collectively “patch panels 106”), wireless router 108, and fiber optic cables 110A-110F, 110X, and 110Y (collectively “cables 110”). Each cable 110 includes a fiber 112 with a connector 114 at each end, and connectors 114 are optical cable interconnect endpoints (a.k.a., cable endpoints) that can engage with other connectors 114 (i.e., plug into each other) at patch panels 106 and with servers 102/104. Because connectors 114 are communicatively connected by fibers 112, connectors 114 can selectively, communicatively connect servers 102/104 and cables 110 together. Patch panels 106 can be brackets that hold connectors 114 of cables 110, for example, for organizational and/or structural purposes, and there can be many cables 110 running between the various patch panels 106 in data center 100 (e.g., cables 110X and 110Y), which is indicated by the three ellipses in FIG. 1. Cables 110X and 110Y can be connected to other hardware (not shown) in data center 100. In addition, new server 104 is shown in phantom as it is a planned addition to data center 100, but new server 104 has not yet been installed. However, the fiber optic pathways have been planned out and cables 110A-110F have been installed so that servers 102/104 will be able to communicate with one another.

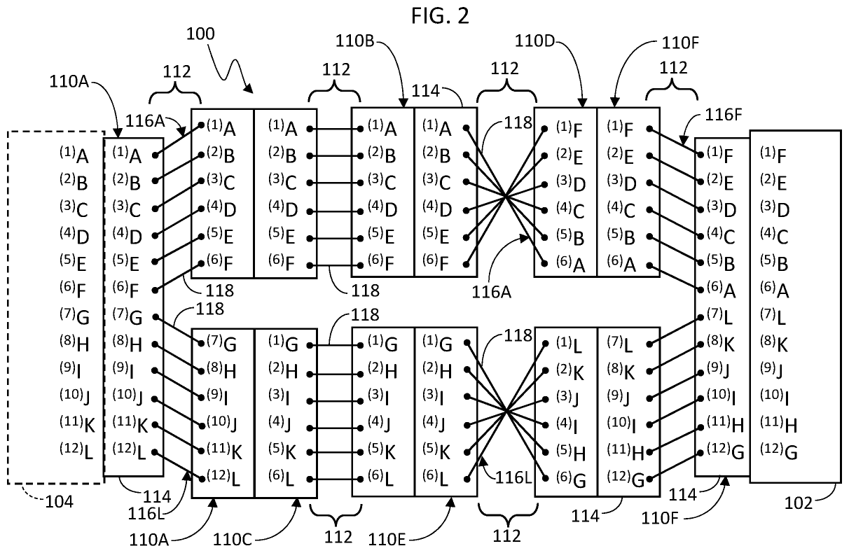

FIG. 2 is a schematic view of communication lanes 116A-116L (collectively “lanes 116”). Lanes 116 are identified in FIG. 2 at each connector 114 and at servers 102/104 only by their alphabetical suffix (e.g., “116A” is labeled as “A”) for the sake of clarity. Lanes 116 run across data center 100, for example, between servers 102/104, and each lane 116 is comprised of multiple segments 118. Segments 118 are a generalized representation, for example, of each individual communication channel in a cable 110 (e.g., filaments in a fiber 112), and segments begin and end at particular positions in connectors 114 that are labeled numerically in superscript. For example, the segment 118 that starts at the first position (labeled “⁽¹⁾”) in cable 110D ends at the sixth position labeled (labeled “⁽⁶⁾”), when moving left to right in FIG. 2). The number of lanes 116 in data center 100 can vary, as can the number of segments 118. For example, each cable 110 can have the same or a different number of segments 118 than is shown in FIG. 2 (e.g., two, four, eight, or twenty-four segments 118). Lanes 116 and segments 118 have been purposely planned out, for example, by a user (not shown) so that servers 102/104 can communicate optically in data center 100. As discussed previously, a large number of cables 110 can be connected to patch panels 106 (shown in FIG. 1), but for the sake of simplicity, these other cables (e.g., cables 110X and 110Y) have been omitted in FIG. 2.

In the illustrated embodiment, each connector 114 pair is keyed so that cables 110 are connected physically and communicatively in the same orientation each time (allowing segments 118 to be connected in a predictable manner). However, depending on the configuration of each cable 110, the paths of lanes 116 can vary. For example, cables 110A-110C and 110F have a Type A polarity (a.k.a. straight) in that each segment 118 starts and ends in the same position. In addition, cables 110D and 110E have a Type B polarity (a.k.a. cross-over or reversed) in that segments 118 end in symmetrically opposite positions from what they started in. Thereby, the segment 118 that starts in the first position ends in the sixth position, the segment 118 that starts in the second position ends in the fifth position, and the segment 118 that starts in the third position ends in the fourth position, and so forth (assuming the cable 110 has six segments, as cables 110D and 110E do). In other embodiments, some or all of cables 110 can have different polarities, such as, for example, a Type C polarity (a.k.a. pairs flipped). With a Type C polarity, each segment 118 is paired up with a partner segment (e.g., pairing the first and the second segments 118) and the two segments 118 end in the position that the other one started in. For example, if cable 110E were a Type C polarity, the segment 118 that starts in the first position ends in the second position, whereas the segment 118 that starts in the second position ends in the first position. Furthermore, the segment 118 that starts in the third position ends in the fourth position, whereas the segment 118 that starts in the fourth position ends in the third position, and so forth.

In the illustrated embodiment, cables 110 can have other architectures (e.g., different lane paths and/or inclusion of switches). For example, from the perspective of new server 104, cable 110A splits lanes 116A-116F from lanes 116G-116L, such that there is a single, twelve lane connector 114 at new server 104, but two, six lane connectors 114 at patch panel 106A (shown in FIG. 1, connected to cables 110B and 110C, respectively). Similarly, but oppositely, from the perspective of new server 104, cable 110F joins lanes 116A-116L again for a single twelve lane connector 114 at existing server 102. The configuration and components of data center 100 allow for optical communication signals to be routed through data center 100 (i.e., between servers 102/104). For example, lane 116A begins in the first position of new server 104 (labeled “⁽¹⁾A”) and ends in the sixth position of existing server 102 (labeled “⁽⁶⁾A”).

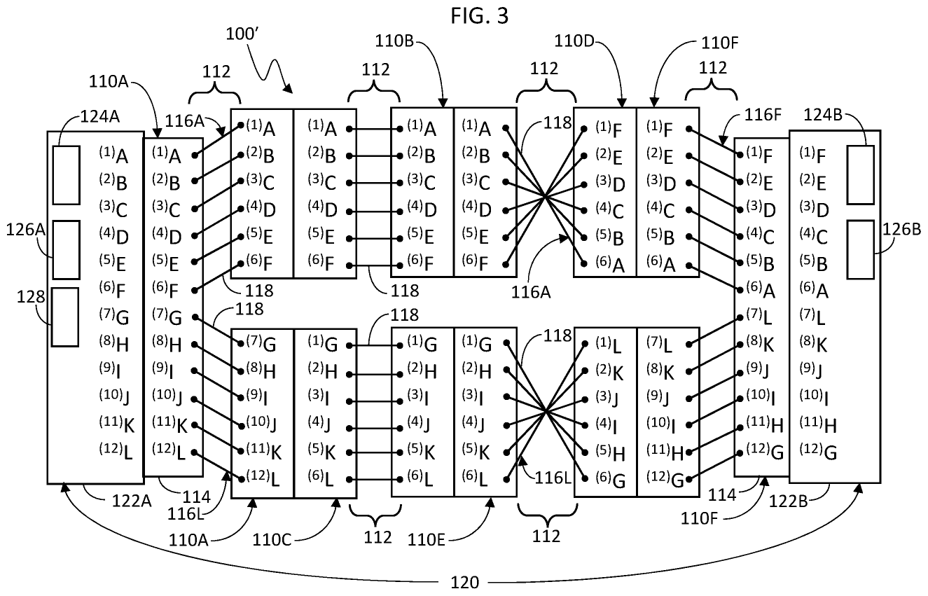

FIG. 3 is a schematic view of testing tool 120 to be connected to some of lanes 116 at different locations inside or outside of data center 100′ (the designation of “data center 100′” is used to indicate that tool 120 is connected to cables 110 instead of servers 102/104). In the illustrated embodiment, testing tool 120 has two separate, portable end units 122A and 122B (collectively “end units 122”). Cables 110 have been connected to each other at patch panels 106 in preparation for the installation of server 104 (shown in FIG. 2), and end unit 122A has been connected to the free end of cable 110A (in the position where new server 104 will go). Existing server 102 has been disconnected from cable 110F (and is not shown in FIG. 3), and instead, end unit 122B has been connected to the free end of cable 110F (in the position that existing server 102 normally is). In this configuration, end units 122 can be relatively close to one another (e.g., meters away) or relatively far away from one another (e.g., kilometers away). Furthermore, testing tool 120 can be relocated to different connectors 114 in data center 100′ to test other optical connections, as desired, including to test single point connections (i.e., end units 122 can be positioned on both ends of the same cable 110).

In the illustrated embodiment, testing tool 120 includes user interfaces (UIs) 124A and 124B (collectively “UIs 124”) and wireless transceivers 126A and 126B (collectively “transceivers 126”) on end units 122, respectively. Each UI 124 can include, for example, an output component (e.g., an array of indicator lights) and/or an input component (e.g., an array of buttons and/or a touch screen), and UIs 124A and 124B can be the same as or different from one another. Transceivers 126 can interface with wireless router 108 (shown in FIG. 1), for example, to allow wireless communication between end units 122 or another computing machine (not shown). However, in some embodiments, only one end unit 122 includes a transceiver 126. Furthermore, end unit 122A includes path database 128, which includes data regarding the intended (i.e., predetermined according to a plan) configuration of data center 100, such as, for example, regarding servers 102/104, cables 110 (e.g., polarities thereof), and connectors 114 (shown in FIG. 2), as well as lanes 116, segments 118, and the intended communication paths between servers 102/104. However, in some embodiments, both end units 122 include a path database 128, and in other embodiments, path database 128 is stored on another computing machine separate from testing tool 120 but communicatively connected to testing tool 120.

In the illustrated embodiment, from the perspective of new server 104, some of lanes 116 are transmitting paths and other lanes 116 are receiving paths. In an example, lanes 116A-116F can be transmitting paths and lanes 116G-116L can be receiving paths. On the other hand, from the perspective of existing server 102, the functions of lanes 116 would be reversed. In such an example, lanes 116G-116L would be transmitting paths and lanes 116A-116F would be receiving paths according to existing server 102. The dichotomy between transmitting paths and receiving paths can be due to the fiber optic hardware configurations of servers 102/104. In some embodiments, testing tool 120 can include optical transceivers on each lane 118 so that end units 122 can communicate bidirectionally (i.e., send and receive) from each position on their respective connectors 114. Thereby, testing tool 120 can use end units 122 to verify that each lane 116 follows its planned path, which ensures proper communication between servers 102/104.

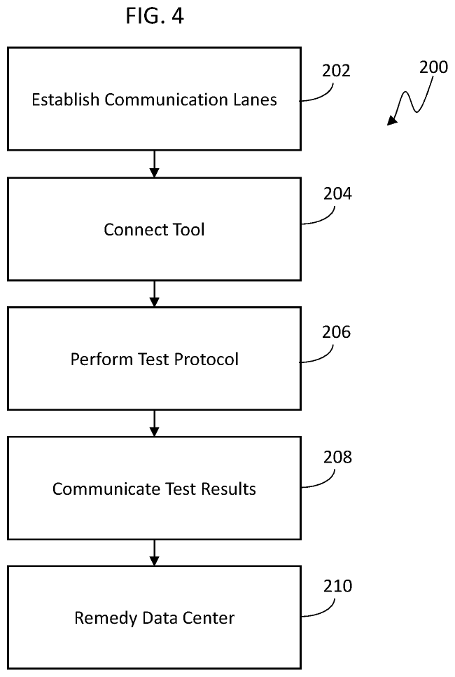

FIG. 4 is a flowchart of method 200 of using testing tool 120. During the discussion of method 200, references may be made to some components discussed with respect to FIGS. 1-3. In the illustrated embodiment, method 200 begins at operation 202, at which lanes 116 are established by planning or structuring the communication paths in data center 100 and selectively connecting cables 110 via connectors 114. At operation 204, existing server 102 is disconnected from cable 110F, and testing tool 120 is connected to each end of the established lanes 116 (i.e., end unit 122A is connected to cable 110A and end unit 122B is connected to cable 110F). At operation 206, a test protocol is performed to verify that each lane 116 starts and/or ends at the intended locations. At operation 208, the results of operation 206 are communicated to a user (not shown). If the results indicate that there is a fault in data center 100, then at operation 210, a remedy can be applied. For example, if testing tool 120 indicates that a cable 110 with an incorrect polarity has been installed in data center 100, then the user can change out that cable 110 with one having the correct polarity in operation 210.

In general, operation 206 can include transmitting optical signals from one end unit 122 to the other end unit 122 via lanes 116. For example, if a signal is sent from the first position on end unit 122A, then end unit 122B should receive that signal on its sixth position because lane 116A is connected to the first position of end unit 122A (labeled “⁽¹⁾A” in FIG. 3) and the sixth position of end unit 122B (labeled “⁽⁶⁾A” in FIG. 3). Similarly, if a signal is sent from the second position on end unit 122A, then end unit 122B should receive that signal on its fifth position because lane 116B is connected to the second position of end unit 122A (labeled “⁽²⁾B” in FIG. 3) and the fifth position of end unit 122B (labeled “⁽⁵⁾A” in FIG. 3).

In the illustrated embodiment, during operation 206, the receiving end unit 122 can monitor all of its communication positions so that it can potentially receive signals from any lane 116A-116L. The optical signals from the transmitting end unit 122 can be sent in a single wavelength (e.g., a color of light within and/or outside of the visible spectrum) from each position sequentially (i.e., one-at-a-time), or the optical signals can be sent in a plurality of different wavelengths simultaneously across all positions with a different wavelength being used for each of the different lanes 116. In the first instance, the separation in time of the signals can be used to determine which position of the receiving end unit 122 each lane 116 ends in. In the second instance, the separation of wavelength of the signals can be used to determine which position of the receiving end unit 122 each lane 116 ends in. This information can be used to determine the pathways of lanes 116 through data center 100 because the order and/or color of the optical signals sent out are known to transmitting end unit 122.

In some embodiments, operation 206 can have two stages-one stage where end unit 122A transmits and end unit 122B receives, and another stage where end unit 122B transmits and end unit 122A receives. This can be beneficial, for example, in cases where some lanes 116 only support unidirectional communication. In addition, this can be beneficial if one or more of cables 110 have the incorrect polarity or are not installed correctly on patch panels 106.

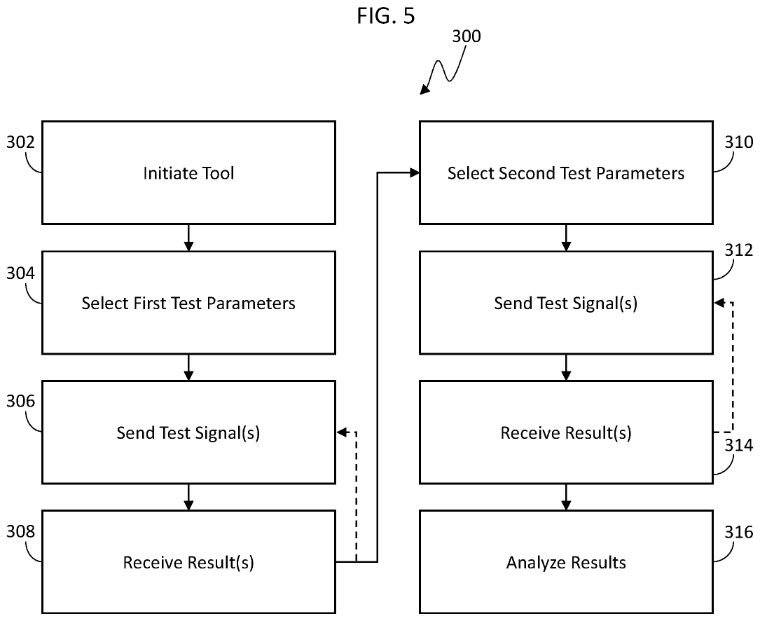

FIG. 5 is a flowchart of method 300 of operating testing tool 120. During the discussion of method 300, references may be made to some components discussed with respect to FIGS. 1-4. For example, method 300 can represent some or all of operations 206 and 208 in method 200. In the illustrated embodiment, method 300 begins at operation 302, where testing tool 120 is initiated (i.e., started up). At operation 304, the first test parameters are selected by a user (or a pair of users wherein each user operates one of end units 122) to govern a test wherein, for example, end unit 122A is the transmitter and end unit 122B is the receiver. In the illustrated embodiment, method 300 occurs without metadata communication between end units 122 about the test signals that will be sent through lanes 116. Thus, the parameters of the signals (i.e., what order and/or wavelengths of the signals) used for the test are either selected from a list of predetermined test parameter sets or the parameters are chosen from a list of options ad hoc. These selections can be made on one or both end units 122 via UIs 124, respectively. However, in some embodiments, there can be fixed parameters that testing tool 120 always uses.

In the illustrated embodiment, at operation 306, at least one test signal is sent, for example, from end unit 122A to end unit 122B (i.e., the first stage). In some embodiments, where the test signals are all sent simultaneously at different wavelengths, operation 306 only occurs once before method 300 advances to operation 308. However, in some embodiments, where the test signals are sent sequentially one-at-a-time, method 300 can advance to operation 308 after each signal and return to operation 306 for the next signal (as indicated by a phantom arrow in FIG. 5) until all the signals have been sent. At operation 308, the result(s) of the signal(s) sent in operation 306 are sent, for example, by the user of end unit 122B and received, for example, by the user of end unit 122A. However, in some embodiments, the results are sent by end unit 122B itself. In such embodiments, operation 308 is performed visually by UI 124B illuminating a light that indicates, for example, what position the signal was received on (in case the signals are sent sequentially). In some embodiments, operation 308 is performed visually by UI 124B illuminating an array of lights that indicates, for example, the wavelength of each signal (or visual spectrum representative thereof) received at each position (in case the signals are sent simultaneously). In some embodiments, operation 308 is performed by UI 124B displaying the order and/or wavelength of the signals that were received and correlating them with their respective positions alphanumerically, which can then be read by the user when the user next interacts with end unit 122B, or by the user's partner that is operating end unit 122B. In some embodiments, correlating the received signals with their respective positions can be accomplished through the use of fixed test parameters (e.g., always sequentially sending signals from the first position to the twelfth position and/or always coding the first position red, the second position orange, etc.) which are known by both end units 122.

In the illustrated embodiment, after receiving all of the results in operation 308, method 300 advances to operation 310. Operation 310 can be similar to that of operation 304 wherein the second test parameters are selected by a user (or a pair of users wherein each user operates one of end units 122) to govern a test wherein, for example, end unit 122B is the transmitter and end unit 122A is the receiver. Operations 312 and 314 can be similar to that of operations 306 and 308, but the signals can be sent from and received by the opposite end units 122 (e.g., transmitted from end unit 122B and received by end unit 122A, i.e., the second stage). After receiving all of the results in operation 314, method 300 advances to operation 316. At operation 316, the test results from operations 308 and 314 are analyzed by the user(s). For example, the user can consult with path database 128 (located in testing tool 120 or on another computing machine) to determine if lanes 116 begin and end at their intended positions. If so, then data center 100 is ready for installation of new server 104 because its communication connections to existing server 102 have been verified. However, if one or more lanes 116 failed to follow their intended paths, then the user can analyze the cables 110 to troubleshoot and reconfigure data center 100 (à la operation 210) before proceeding with installation of new server 104.

Operating testing tool 120 according to method 300 provides a relatively simple and straightforward process for verifying that cables 110 and lanes 116 are correct without having to install, connect, and operate servers 102/104. However, the visual indication of method 300 can be more difficult to utilize if end units 122 are far apart (e.g., out of sight of one another). In such situations, there can be a user for each end unit 122 that can communicate the steps being taken in method 300 to each other via an alternate communication medium (e.g., using cellular telephones).

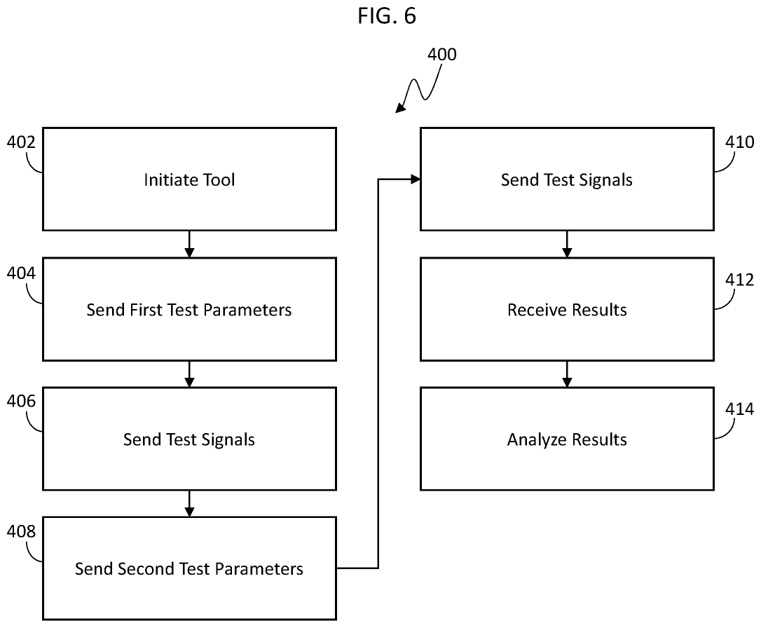

FIG. 6 is a flowchart of an alternative method 400 of operating testing tool 120. During the discussion of method 400, references may be made to some components discussed with respect to FIGS. 1-4. For example, method 400 can represent some or all of operations 206 and 208 in method 200. In the illustrated embodiment, method 400 begins at operation 402, where testing tool 120 is initiated (i.e., started up). At operation 404, the first test parameters are sent from the transmitting end unit 122 to the receiving end unit 122 (e.g., from end unit 122A to end unit 122B) using optical signals, with advantages including that a single user can operate testing tool 120 and no additional hardware is needed to communicate between end units 122. This transmission is a metadata communication in that it describes the first test itself and occurs separately from the test signals being sent. In some embodiments, the metadata communication is sent as digital signals whereas the testing signals are sent as analog signals sent at particular wavelengths.

In some embodiments, the transmission at operation 404 occurs using some or all of the respective lanes 116, with advantages of using all respective lanes 116 including that the message will be received even if some of lanes 116 do not reach the receiving end unit 122. In other embodiments, the transmission occurs using an alternate communication medium (e.g., using wireless router 108 and/or a cellular network), with advantages of using the alternate communication medium including that the message will be received even if none of lanes 116 reach the receiving end unit 122. Operation 404 can include sending the parameters of the signals (e.g., what order and/or wavelengths of the signals) as well as information about lanes 116 being tested (e.g., what signal should be received at what position). In some embodiments, the information about lanes 116 being tested can be retrieved from path database 128 (shown in FIG. 3). In some embodiments, operation 404 involves user input (e.g., selection of test parameters, the polarities of cables 110 between end units 122, what signal should be received at what position, and/or an indication of which cables 110 and/or lanes 116 in data center 100 are being tested), but in some embodiments, no user input is required.

At operation 406, the first test signals are sent (e.g., from end unit 122A to end unit 122B, i.e., the first stage). Then, method 400 advances to operation 408, which can be similar to operation 404 with the second test parameters being sent from and received by the opposite end units 122 (e.g., transmitted from end unit 122B and received by end unit 122A). However, in some embodiments, operation 408 is combined into operation 404 because the initially transmitting end unit 122 (e.g., end unit 122A) can specify the second test parameters. At operation 410, the second test signals are sent (i.e., the second stage), and at operation 412, the results of the first and second tests are received by one or both of end units 122. For example, if only end unit 122A is being used to analyze the results in operation 414, then end unit 122B sends the results of the first test to end unit 122A (since the results of the second test will be known to end unit 122A because end unit 122A was the receiver in the second test). The message sent in operation 412 can be sent through one or more of the tested lanes 116 or using the alternate communication medium. The results of the test in operation 412 can be, for example, which signals were received at which positions and/or whether the test was successful based on where the signals were expected to be received versus where the test signals were actually received.

At operation 414, the test results from operation 412 are analyzed, for example, by a user and/or by testing tool 120 itself to determine if cables 110 are correct by analyzing whether lanes 116 begin and end at their intended positions. If so, then data center 100 is ready for installation of new server 104 because the communication connections to existing server 102 have been verified. However, if one or more lanes 116 failed to follow their intended paths, then the user can analyze the cables 110 to troubleshoot data center 100 before proceeding with installation of new server 104.

Operating testing tool 120 according to method 400 involves end units 122 communicating metadata about the testing being performed, but method 400 requires less from the user(s) to verify that cables 110 and lanes 116 are correct when compared to method 300. In addition, method 400 can be executed even by a single user despite end units 122 being far apart (e.g., out of sight of one another).

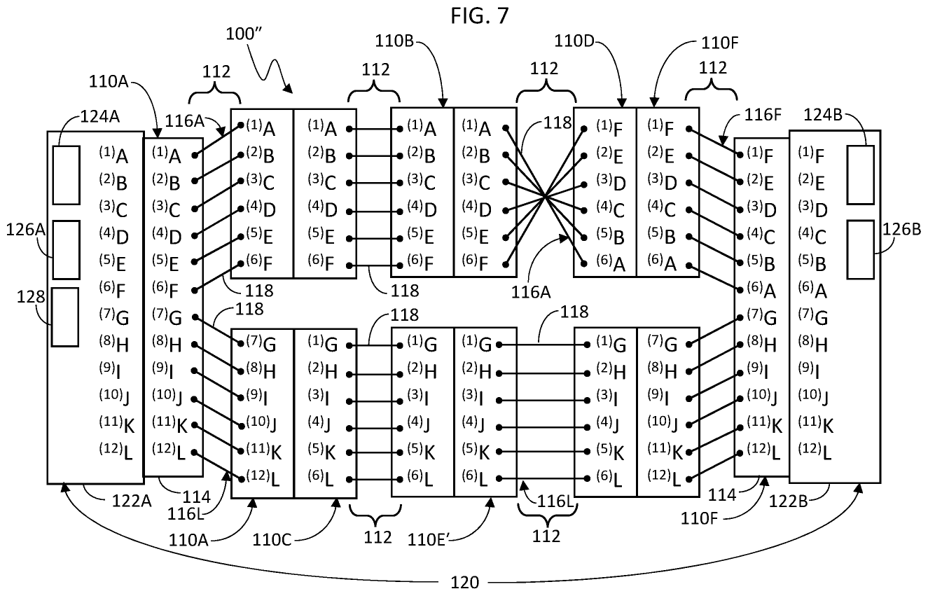

FIG. 7 is a schematic view of testing tool 120 connected to erroneously connected lanes 116 in data center 100″. In contrast with the correctly connected lanes 116 of data center 100′ (shown in FIG. 3), the polarity of cable 110E′ is Type A, which is inverted compared to the Type B polarity of cable 110E (shown in FIG. 3). This error would be discovered during the performance of method 200 (shown in FIG. 4) (which could include some or all of methods 300 and/or 400, shown in FIGS. 5 and 6, respectively).

In the illustrated embodiment, assuming that lanes 116G-116I provide unidirectional communication from new server 104 to existing server 102 (both shown in FIG. 1) and that the first test was of lanes 116G-116I from end unit 122A to end unit 122B, then cable 110E′ would be discovered when the first test revealed that lane 116G ended at the seventh position despite being intended to end at the twelfth, lane 116H ended at the eighth position despite being intended to end at the eleventh, and lane 116I ended at the ninth position despite being intended to end at the tenth. Similarly, assuming that lanes 116J-116L provide unidirectional communication from existing server 102 to new server 104, then the error would be confirmed when the second test of lanes 116J-116L from end unit 122B to end unit 122A occurs. Because it would be assumed that lanes 116J-116L were occupying the ninth, tenth, and eleventh positions, the second test would reveal to end unit 122B that “lane 116J” (which is actually lane 116I) ended at the ninth position despite being intended to end at the tenth, “lane 116K” (which is actually lane 116H) ended at the eighth position despite being intended to end at the eleventh, and “lane 116L” (which is actually lane 116G) ended at the seventh position despite being intended to end at the twelfth. The discovery that lanes 116G-116L do not end where they were intended to allows a user to quickly identify that there is an issue with the fiber optic cables 110 in data center 100″. This can reduce the downtime required to remedy the problem because the problem was found prior to new server 104 being installed.

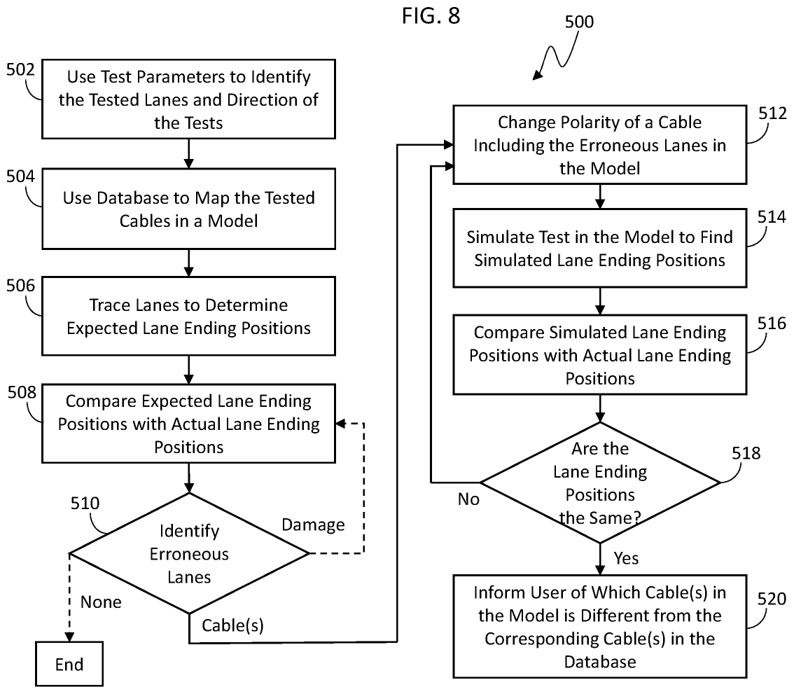

FIG. 8 is a flowchart of method 500 of analyzing test results using path database 128 (shown in FIG. 1). During the discussion of method 500, references may be made to some components discussed with respect to FIGS. 1-7. For example, method 500 can represent some or all of operation 208 in method 200 and/or operation 414 in method 400. In addition, method 500 can be performed by testing tool 120 (i.e., end unit 122A and/or 122B) or by another computing machine with access to path database 128. In the illustrated embodiment, method 500 begins at operation 502, where testing tool 120 uses the test parameters to identify which lanes 116 have been tested and in which directions (e.g., from end unit 122A to end unit 122B or vice versa). At operation 504, testing tool 120 creates a model or virtual simulation of a portion of data center 100′ (or of data center 100) using the information in path database 128 to map the tested lanes 116. In some embodiments, the model can be limited to some or all of the tested lanes 116, but in some embodiments, more of data center 100′ is modeled (e.g., all of the lanes 116 that are connected to the same patch panels 106 that the tested lanes 116 are connected to). At operation 506, testing tool 120 traces each of the tested lanes 116 to determine their expected ending positions.

In the illustrated embodiment, at operation 508, these expected ending positions of lanes 116 are compared to their actual ending positions from the testing on data center 100″ (i.e., including the signals sent through erroneously placed cable 110E′). At operation 510, the erroneous lanes 116 are identified, for example, by determining which lanes 116 end in incorrect positions, and method 500 would advance to operation 512 (as indicated by the line labeled “Cable(s)” in FIG. 8). Operation 510 can include analyzing if any lanes 116 did not receive and/or transmit any signals despite other lanes 116 in the same cables 110 doing so. Such a situation could indicate that one or more segments 118 (e.g., filaments in fiber 112) are damaged but others are functional. In some embodiments, method 500 would immediately inform the user which cables 110 might be affected and halt performance of method 500. Once the user remedies the affected cable(s) 110, data center 100″ can be retested (e.g., using method 300 or 400) and method 500 may resume using the new test results at operation 508 (as indicated by the phantom line labeled “Damage” in FIG. 8). However, if no erroneous lanes are identified in operation 510, then method 500 ends (as indicated by the phantom line labeled “None” in FIG. 8).

In the illustrated embodiment, at operation 512, the polarity of one of the cables 110 that includes an erroneous lane 116 is changed in the model (i.e., cables 110A, 110C, 110E, or 110F). At operation 514, the testing is simulated using the modified model to find simulated ending positions, and the simulated ending positions are determined. At operation 516, the simulated ending positions are compared to the actual ending positions. At operation 518, if the simulated ending positions are not the same as the actual ending positions, then method 500 reverts to operation 512. In the next loop-back of operations 512-518, the originally changed cable 110 can change to yet another polarity and/or a different cable 110 can be changed. The loop-backs of operations 512-518 can occur repeatedly, if necessary, to cover all of the different permutations that could exist in the affected portions of data center 100″.

However, if the simulated ending positions are the same as the actual ending positions at operation 518, then method 500 advances to operation 520. At operation 520, the user is informed of the erroneous cable(s) 110 (e.g., cable 110E′), and the user is informed of the correct cable(s) 110 (e.g., cable 110E) to use based on path database 128, for example, using UI 126A, UI 126B, and/or another computing machine. Thereby, a user can use testing tool 120 to test lanes 116 and receive solutions to errors involving cables 110 automatically.

Furthermore, in some embodiments, method 500 may exhaust every different combination of cables 110 during the loop-backs of operations 512-518 and never match with the intended configuration. In such a situation, tool 120 can determine that there is a damaged cable 110 in data center 100″. Such an error can be isolated, for example, by analyzing which lanes 116 do not receive a signal during operations 508.

Various embodiments of the present disclosure are described herein with reference to the related drawings. Alternative embodiments can be devised without departing from the scope of the present disclosure. It is noted that various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus. In addition, any numerical ranges included herein are inclusive of their boundaries unless explicitly stated otherwise.

The following are non-exclusive descriptions of some exemple embodiments of the present disclosure.

A method of testing fiber optic communication lanes according to an exemplary embodiment of this disclosure, among other possible things, includes: sending a first plurality of test parameters by a first end unit of a testing tool to a second end unit of the testing tool through at least one communication lane of a plurality of communication lanes that extend from a first cable endpoint to a second cable endpoint through at least a first fiber optic cable, where: the first cable endpoint is connected to the first end unit and the second cable endpoint is connected to the second end unit; and the first plurality of test parameters comprises a plurality of wavelengths of a first plurality of test signals; sending the first plurality of test signals by the first end unit to the second end unit through the plurality of communication lanes; and receiving test results by the first end unit from the second end unit through the at least one communication lane of the plurality of communication lanes. Such a method can provide the technical effect and/or advantage of verifying that each communication lane follows its planned path, which ensures proper communication between components (e.g., servers) at each end of the communication lanes.

The method of the preceding paragraph can optionally include, additionally and/or alternatively, any one or more of the following features, configurations, and/or additional components:

In a further embodiment of the foregoing method, each of the first plurality of test signals has a different wavelength of the plurality of wavelengths. Such an embodiment can provide the technical effect and/or advantage of allowing multiple test signals to be sent simultaneously.

In a further embodiment of any of the foregoing methods, each of the first plurality of test signals is sent on a different one of the plurality of communication lanes. Such an embodiment can provide the technical effect and/or advantage of allowing the second end unit to determine which positions the communication lanes ended at.

In a further embodiment of any of the foregoing methods, the method further comprises receiving a second plurality of test signals by the first end unit from the second end unit through the plurality of communication lanes. Such an embodiment can provide the technical effect and/or advantage of verifying that each communication lane follows its planned path, which ensures proper communication between components (e.g., servers) at each end of the communication lanes by testing in the opposite direction from the first plurality of test signals.

In a further embodiment of any of the foregoing methods, the first plurality of test parameters comprises a plurality of wavelengths of the second plurality of test signals. Such an embodiment can provide the technical effect and/or advantage of informing the second end unit of what to expect to the first plurality of test signals to be.

In a further embodiment of any of the foregoing methods, the method further comprises receiving a second plurality of test parameters by the first end unit from the second end unit. Such an embodiment can provide the technical effect and/or advantage of informing the first end unit of what to expect to the second plurality of test signals to be.

In a further embodiment of any of the foregoing methods, the method further comprises analyzing the first plurality of test signals to determine if the first fiber optic cable has a correct polarity to connect each of the plurality of communication lanes as intended in a data center. Such an embodiment can provide the technical effect and/or advantage of allowing a user to determine if the data center needs to be reconfigured.

In a further embodiment of any of the foregoing methods, the method further comprises determining that the first fiber optic cable has an incorrect polarity based on the analyzing of the first plurality of test signals; and suggesting, by the tool, a correct polarity for the first fiber optic cable. Such an embodiment can provide the technical effect and/or advantage of informing a user how to reconfigure the data center.

In a further embodiment of any of the foregoing methods, determining that the first fiber optic cable has an incorrect polarity comprises comparing intended ending positions of each communication lane of the plurality of communication lanes with respect to the second end unit with actual ending positions of each of the plurality of communication lanes included in the test results. Such an embodiment can provide the technical effect and/or advantage of checking each communication lane to eliminate the possibility of damage to one or more filaments as the problem with the data center.

In a further embodiment of any of the foregoing methods, the method further comprises modeling the plurality of communication lanes based an intended configuration of the data center; changing a polarity of the first fiber optic cable in the model; and simulating a test using the model with the changed polarity of the first fiber optic cable. Such an embodiment can provide the technical effect and/or advantage of troubleshooting the data center to find the incorrect and/or damaged cables therein.

In a further embodiment of any of the foregoing methods, the method further comprises monitoring each of the plurality of communication lanes by the second end unit during the sending the first plurality of test signals. Such an embodiment can provide the technical effect and/or advantage of increasing the chances of receiving the test signals even if the communication lanes are incorrectly routed.

In a further embodiment of any of the foregoing methods, the method further comprises disconnecting the first fiber optic cable from a server; and connecting the first end unit to the first fiber optic cable. Such an embodiment can provide the technical effect and/or advantage of allowing the tool to be used in a position where an existing server has already been installed.

In a further embodiment of any of the foregoing methods, where: the first fiber optic cable includes the first cable endpoint; a second fiber optic cable includes the second cable endpoint; and the first fiber optic cable and the second fiber optic cable are connected to a patch panel. Such an embodiment can provide the technical effect and/or advantage of allowing the communication lanes to extend through multiple cables in a structured cabling environment.

A fiber optic communication lanes testing system, according to an exemplary embodiment of this disclosure, among other possible things, includes: a first end unit configured to connect to a first cable endpoint of a first fiber optic cable and configured to send metadata communication about a test and to send optical test signals through at least some of the communication lanes in the first fiber optic cable; a second end unit configured to connect to a second cable endpoint that is communicatively connected to the first cable endpoint and configured to receive the metadata communication about the test and the optical test signals from at least some of the communication lanes in the first fiber optic cable; and a path database communicatively connected to at least one of the first end unit and the second end unit, the path database comprising data representing intended communication lanes through a data center to connect a first server to a second server, where the intended communication lanes extend through at least the first fiber optic cable. Such a system can provide the technical effect and/or advantage of allowing the testing system to determine where communication lanes are intended to go in the data center, which can be verified using the optical test signals.

The fiber optic communication lanes testing system of the preceding paragraph can optionally include, additionally and/or alternatively, any one or more of the following features, configurations, and/or additional components:

In a further embodiment of the foregoing fiber optic communication lanes testing system, the first end unit is configured to send each of the optical test signals at a different wavelength and on a different communication lane. Such an embodiment can provide the technical effect and/or advantage of allowing multiple test signals to be sent simultaneously.

In a further embodiment of any of the foregoing fiber optic communication lanes testing systems, the metadata communication includes which different wavelengths are sent on which different communication lanes. Such an embodiment can provide the technical effect and/or advantage of allowing the second end unit to determine which positions the communication lanes ended at.

A method of testing fiber optic communication lanes, according to an exemplary embodiment of this disclosure, among other possible things, includes: receiving test parameters from a first end unit of a testing tool by a second end unit of the testing tool through at least one of a plurality of communication lanes that extend from a first cable endpoint to a second cable endpoint through at least a first fiber optic cable, where: the first cable endpoint is connected to the first end unit and the second cable endpoint is connected to the second end unit; the test parameters comprise an order of the test signals; receiving the test signals from the first end unit by the second end unit through the plurality of communication lanes; and analyzing the test signals based on the test parameters to determine if the first fiber optic cable has a correct polarity to connect each of the plurality of communication lanes as intended in a data center. Such a method can provide the technical effect and/or advantage of allowing the testing tool to be used where the is not an additional means of communication (other than the communication lanes themselves) and/or where there are great distances between the end units of the testing tool.

The method of the preceding paragraph can optionally include, additionally and/or alternatively, any one or more of the following features, configurations, and/or additional components:

In a further embodiment of the foregoing method, each of the test signals is correlated with one of the plurality of communication lanes in the test parameters. Such an embodiment can provide the technical effect and/or advantage of allowing the second end unit to determine which positions the communication lanes ended at.

In a further embodiment of any of the foregoing methods, the method further comprises displaying a result of the analysis of the test signals on a user interface of the second end unit. Such an embodiment can provide the technical effect and/or advantage of allowing the user to receive the results of the testing.

In a further embodiment of any of the foregoing methods, the method further comprises sending subsequent test parameters of a subsequent test by the second end unit to the first end unit. Such an embodiment can provide the technical effect and/or advantage of allowing testing in the opposite direction from the initial test.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of testing fiber optic communication lanes, the method comprising:
sending a first plurality of test parameters by a first end unit of a testing tool to a second end unit of the testing tool through at least one communication lane of a plurality of communication lanes that extend from a first cable endpoint to a second cable endpoint through at least a first fiber optic cable, wherein:
the first cable endpoint is connected to the first end unit and the second cable endpoint is connected to the second end unit; and
the first plurality of test parameters comprises a plurality of wavelengths of a first plurality of test signals;
sending the first plurality of test signals by the first end unit to the second end unit through the plurality of communication lanes; and
receiving test results by the first end unit from the second end unit through the at least one communication lane of the plurality of communication lanes.

2. The method of claim 1, wherein each of the first plurality of test signals has a different wavelength of the plurality of wavelengths.

3. The method of claim 2, wherein each of the first plurality of test signals is sent on a different one of the plurality of communication lanes.

4. The method of claim 1, further comprising receiving a second plurality of test signals by the first end unit from the second end unit through the plurality of communication lanes.

5. The method of claim 4, wherein the first plurality of test parameters comprises a plurality of wavelengths of the second plurality of test signals.

6. The method of claim 4, further comprising receiving a second plurality of test parameters by the first end unit from the second end unit.

7. The method of claim 1, further comprising analyzing the first plurality of test signals to determine if the first fiber optic cable has a correct polarity to connect each of the plurality of communication lanes as intended in a data center.

8. The method of claim 7, further comprising:
determining that the first fiber optic cable has an incorrect polarity based on the analyzing of the first plurality of test signals; and
suggesting, by the tool, a correct polarity for the first fiber optic cable.

9. The method of claim 8, wherein determining that the first fiber optic cable has an incorrect polarity comprises comparing intended ending positions of each communication lane of the plurality of communication lanes with respect to the second end unit with actual ending positions of each of the plurality of communication lanes included in the test results.

10. The method of claim 8, further comprising:
modeling the plurality of communication lanes based on an intended configuration of the data center;
changing a polarity of the first fiber optic cable in the model; and
simulating a test using the model with the changed polarity of the first fiber optic cable.

11. The method of claim 1, further comprising monitoring each of the plurality of communication lanes by the second end unit during the sending the first plurality of test signals.

12. The method of claim 1, further comprising:
disconnecting the first fiber optic cable from a server; and
connecting the first end unit to the first fiber optic cable.

13. The method of claim 1, wherein:
the first fiber optic cable includes the first cable endpoint;
a second fiber optic cable includes the second cable endpoint; and
the first fiber optic cable and the second fiber optic cable are connected to a patch panel.

14. A fiber optic communication lanes testing system comprising:
a first end unit configured to connect to a first cable endpoint of a first fiber optic cable and configured to send metadata communication about a test and to send optical test signals through at least some of the communication lanes in the first fiber optic cable;
a second end unit configured to connect to a second cable endpoint that is communicatively connected to the first cable endpoint and configured to receive the metadata communication about the test and the optical test signals from at least some of the communication lanes in the first fiber optic cable; and
a path database communicatively connected to at least one of the first end unit and the second end unit, the path database comprising data representing intended communication lanes through a data center to connect a first server to a second server, wherein the intended communication lanes extend through at least the first fiber optic cable.

15. The fiber optic communication lanes testing system of claim 14, wherein the first end unit is configured to send each of the optical test signals at a different wavelength and on a different communication lane.

16. The fiber optic communication lanes testing system of claim 15, wherein metadata communication includes which different wavelengths are sent on which different communication lanes.

17. A method of testing fiber optic communication lanes, the method comprising:
receiving test parameters from a first end unit of a testing tool by a second end unit of the testing tool through at least one of a plurality of communication lanes that extend from a first cable endpoint to a second cable endpoint through at least a first fiber optic cable, wherein:
the first cable endpoint is connected to the first end unit and the second cable endpoint is connected to the second end unit; and
the test parameters comprise an order of the test signals;
receiving the test signals from the first end unit by the second end unit through the plurality of communication lanes; and
analyzing the test signals based on the test parameters to determine if the first fiber optic cable has a correct polarity to connect each of the plurality of communication lanes as intended in a data center.

18. The method of claim 17, wherein each of the test signals is correlated with one of the plurality of communication lanes in the test parameters.

19. The method of claim 17, further comprising displaying a result of the analysis of the test signals on a user interface of the second end unit.

20. The method of claim 17, further comprising sending subsequent test parameters of a subsequent test by the second end unit to the first end unit.
